(19) United States
(12) Patent Application Publication
(10) Pub. No.: US 2024/0351564 A1
(43) Pub. Date: Oct. 24, 2024

(54) FRONT AXLE SPEED COMMAND INTERFACE

(71) Applicant: CNH Industrial America LLC, New Holland, PA (US)

(72) Inventors: Daniel Payne, Westmont, IL (US); Pawel Kuros, Mt. Prospect, IL (US)

(21) Appl. No.: 18/137,004

(22) Filed: Apr. 20, 2023

(51) Int. Cl. B60T 8/24

(52) U.S. Cl. CPC B60T 8/246; B60T 2201/16; B60T 2270/88

(57) ABSTRACT

A system and a method for controlling a front axle speed of a work vehicle includes a sensor configured to determine an amount a steering wheel is being turned. The system includes a pair of pressure sensors configured to measure an amount of pressure applied to a corresponding brake of a pair of unlinked brakes. The system includes a control system configured to receive both a first input signal indicative of the amount the steering wheel is being turned and a second input signal indicative of the amount of pressure applied to the respective brake and to provide a control signal to independently control a speed of a front axle from a rear axle when conducting a turn under power based on the amount of pressure applied to the respective brake when the amount the steering wheel is being turned at least meets a predetermined turning threshold.

### BACKGROUND

The present disclosure relates generally to work vehicles and, more particularly, to a front axle speed command interface.

This section is intended to introduce the reader to various aspects of art that may be related to various aspects of the present disclosure, which are described below. This discussion is believed to be helpful in providing the reader with background information to facilitate a better understanding of the various aspects of the present disclosure. Accordingly, it should be understood that these statements are to be read in this light, and not as admissions of prior art.

In work vehicles (e.g., off-road vehicle such as a tractor) the front axle speed is fixed to the rear axle speed by a mechanical front drive clutch when it is driven. Alternatively, the front axle can be disconnected from the drivetrain and freewheel but not put any power into the ground. Commanding the front axle to turn at the correct average speed for a given turn radius while powered improves steering performance and reduces damage to the soil from the tires skidding. However, in certain circumstances, it might be desirable to turn more tightly than the turning radius given by the steering angle. For example, a 40 degree steering angle may result in a theoretical 5 meter turning radius but actually results in an 8 metering turning radius. Even turning the front axle at the correct speed still only achieves a 6 meter turning radius.

### BRIEF DESCRIPTION

This brief description is provided to introduce a selection of concepts that are further described below in the detailed description. This summary is not intended to identify key or essential features of the claimed subject matter, nor is it intended to be used as an aid in limiting the scope of the claimed subject matter.

In one embodiment, a work vehicle is provided. The work vehicle includes a front axle and a rear axle. The work vehicle also includes a steering system configured to turn the work vehicle, the steering system including a steering wheel and a sensor to determine an amount the steering wheel is being turned. The work vehicle further includes a braking system configured to slow down the work vehicle. The braking system includes a pair of unlinked brakes, wherein each brake is coupled to a respective pressure sensor configured to measure an amount of pressure applied to a corresponding brake of the pair of unlinked brakes. The work vehicle further includes a control system configured to receive both a first input signal, from the sensor, indicative of the amount the steering wheel is being turned and a second input signal, from the respective pressure sensor of a respective brake of the pair of unlinked brakes, indicative of the amount of pressure applied to the respective brake corresponding to a turn direction of the steering wheel. The control system is configured to provide a control signal to independently control a speed of the front axle from the rear axle when conducting a turn under power based on the amount of pressure applied to the respective brake when the amount the steering wheel is being turned at least meets a predetermined turning threshold.

In another embodiment, a system for controlling a front axle speed of a work vehicle is provided. The system includes a sensor configured to determine an amount a steering wheel of the work vehicle is being turned. The system also includes a pair of pressure sensors, wherein each pressure sensor of the pair of pressure sensors is configured to measure an amount of pressure applied to a corresponding brake of a pair of unlinked brakes of the work vehicle. The system further includes a control system configured to receive both a first input signal, from the sensor, indicative of the amount the steering wheel is being turned and a second input signal, from a respective pressure sensor of a respective brake of the pair of unlinked brakes, indicative of the amount of pressure applied to the respective brake corresponding to a turn direction of the steering wheel. The control system is configured to provide a control signal to independently control a speed of a front axle of the work vehicle from a rear axle of the work vehicle when conducting a turn under power based on the amount of pressure applied to the respective brake when the amount the steering wheel is being turned at least meets a predetermined turning threshold.

In a further embodiment, a method for controlling a front axle speed of a work vehicle is provided. The method includes receiving, at a processor of the work vehicle, a first input signal, from a sensor, indicative of an amount a steering wheel of the work vehicle is being. The method also includes receiving, at the processor, a second input signal, from a respective pressure sensor of a respective brake of a pair of unlinked brakes of the work vehicle, indicative of an amount of pressure applied to the respective brake corresponding to a turn direction of the steering wheel. The method further includes providing, via the processor, a control signal to independently control a speed of a front axle of the work vehicle from a rear axle of the work vehicle when conducting a turn under power based on the amount of pressure applied to the respective brake when the amount the steering wheel is being turned at least meets a predetermined turning threshold.

### BRIEF DESCRIPTION OF THE DRAWINGS

These and other features, aspects, and advantages of the present subject matter will become better understood when the following detailed description is read with reference to the accompanying drawings in which like characters represent like parts throughout the drawings, wherein:

FIG. 1 is a perspective of view of a work vehicle (e.g., tractor), in accordance with aspects of the disclosure:

FIG. 2 is a schematic block diagram of the work vehicle in FIG. 1, in accordance with aspects of the present disclosure:

FIG. 3 is a schematic block diagram of a driveline of the work vehicle in FIG. 1, in accordance with aspects of the present disclosure; and

FIG. 4 is a flow chart of a method for controlling a front axle speed of a work vehicle, in accordance with aspects of the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

Embodiments of the present disclosure relate generally to a front axle speed command interface for a work vehicle (e.g., off-road vehicle such as a tractor). In certain embodiments, the work vehicle is a four wheel drive vehicle. In particular, brake pedals are utilized to control the front axle speed of the work vehicle. For example, the work vehicle includes a front axle and a rear axle. The work vehicle also includes a steering system configured to turn the work vehicle, the steering system including a steering wheel and a sensor (e.g., steering angle sensor) to determine an amount (number of degrees) the steering wheel is being turned. The work vehicle further includes a braking system configured to slow down the work vehicle. The braking system includes a pair of unlinked brakes, wherein each brake is coupled to a respective pressure sensor (e.g., where the respective pressure sensors are disposed on or coupled to the hydraulic lines of the respective brakes) configured to measure an amount of pressure applied to a corresponding brake (e.g., left brake when turning left and right brake when turning right) of the pair of unlinked brakes. The work vehicle further includes a control system configured to receive both a first input signal, from the sensor, indicative of the amount the steering wheel is being turned and a second input signal, from the respective pressure sensor of a respective brake of the pair of unlinked brakes, indicative of the amount of pressure applied to the respective brake corresponding to a turn direction of the steering wheel. The control system is configured to provide a control signal to independently control a speed of the front axle from the rear axle when conducting a turn under power based on the amount of pressure applied to the respective brake when the amount the steering wheel is being turned at least meets a predetermined turning threshold.

The control system is also configured to provide the control signal to increase the speed of the front axle until the speed of the front axle is greater than a speed required to match a ground speed of the work vehicle. The control system is further configured to provide the control signal to increase the speed of the front axle in correspondence with increasing the amount of pressure applied to the respective brake. In certain embodiments, the control system is configured to provide the control signal to increase the speed of the front axle in correspondence with increasing the amount of pressure applied to the respective brake until reaching a maximum speed of the front axle. In certain embodiments, the control system is configured to provide the control signal to increase the speed of the front axle in correspondence with increasing the amount of pressure applied to the respective brake until reaching a maximum amount of pressure applied to the respective brake. In certain embodiments, the control system is even further configured to provide the control signal to increase the speed of the front axle to a maximum speed upon the amount of pressure applied to the respective brake reaching a predetermined pressure threshold. The disclosed embodiments enables the front axle to be driven to a commended speed independent of grip. The disclosed embodiments also enable the front axle to be oversped (i.e., to turn faster that what is needed to match ground speed) to enable a tighter than expected turn (e.g., a 4.5 meter turning radius when a 40 degree steering angle theoretically results in a 5 meter turning radius). In certain embodiments, a separate device (instead of the brake pedals) may be utilized an input device to the control system to control the front axle speed.

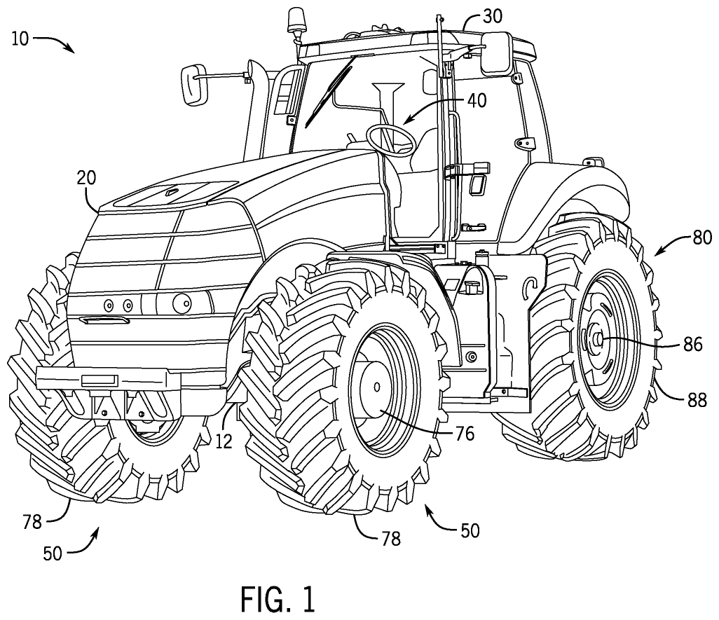

FIGS. 1-3 illustrate a machine or work vehicle, shown as work vehicle 10, includes a chassis, shown as frame 12. The work vehicle 10 also includes a body assembly, shown as body 20, coupled to the frame 12 and having an occupant portion or section, shown as cab 30. The work vehicle 10 further includes operator input and output devices, shown as operator interface 40, that are disposed within the cab 30. The work vehicle even further includes a drivetrain, shown as driveline 50, coupled to the frame 12 and at least partially disposed under the body 20. The work vehicle 10 yet further includes a vehicle braking system, shown as braking system 100, coupled to one or more components of the driveline 50 to facilitate selectively braking the one or more components of the driveline 50 (e.g., left wheel or right wheel or both the left and right wheels of rear axle). The work vehicle 10 even further includes a vehicle control system, shown as control system 200, coupled to the operator interface 40, the driveline 50, and the braking system 100. In other embodiments, the work vehicle 10 includes more or fewer components.

In certain embodiments, the work vehicle 10 is an off-road machine or vehicle. In some embodiments, the off-road machine or vehicle is an agricultural machine or vehicle such as a tractor, a telehandler, a front loader, a combine harvester, a grape harvester, a forage harvester, a sprayer vehicle, a speedrower, and/or another type of agricultural machine or vehicle. In some embodiments, the off-road machine or vehicle is a construction machine or vehicle such as a skid steer loader, an excavator, a backhoe loader, a wheel loader, a bulldozer, a telehandler, a motor grader, and/or another type of construction machine or vehicle. In some embodiments, the work vehicle 10 includes one or more attached implements and/or trailed implements such as a front mounted mower, a rear mounted mower, a trailed mower, a tedder, a rake, a baler, a plough, a cultivator, a rotavator, a tiller, a harvester, and/or another type of attached implement or trailed implement.

The cab 30 is configured to provide seating for an operator (e.g., a driver, etc.) of the work vehicle 10. In some embodiments, the cab 30 is configured to provide seating for one or more passengers of the work vehicle 10. The operator interface 40 is configured to provide an operator with the ability to control one or more functions of and/or provide commands to the work vehicle 10 and the components thereof (e.g., turn on, turn off, drive, turn, brake, engage various operating modes, raise/lower an implement, etc.). The operator interface 40 may include one or more displays and one or more input devices. The one or more displays may be or include a touchscreen, a LCD display, a LED display, a speedometer, gauges, warning lights, etc. The one or more input device may be or include a steering wheel, a joystick, buttons, switches, knobs, levers, an accelerator pedal, a brake pedal, etc. As depicted, the operator interface 40 includes a steering wheel 42 to turn the work vehicle 10. The steering wheel 42 is part of a steering system 44. The steering system 44 includes a sensor 46 (e.g., steering wheel sensor) configured to determine an amount (e.g., the number of degrees) that the steering wheel 42 is being turned and a direction that the steering wheel 42 is being turned. The sensor 46 may be an optical sensor, magnetic sensor, inductive sensor, capacitive sensor, or resistive sensor. The sensor 46 is in communication with the control system 200 and provides feedback (e.g., signals) related to the amount the steering wheel 42 is being turned and the direction that the steering wheel 42 is being turned. In certain embodiments, the sensor 46 may be located on the front axle (e.g., front axle 76 in FIG. 3) and measure a rotation of a knuckle (e.g., steering knuckle) relative to an axle beam to determine an amount the steering wheel 42 is being turned and the direction that the steering wheel 42 is being turned.

The driveline 50 is configured to propel the work vehicle 10. As shown in FIG. 3, the driveline 50 includes a primary driver, shown as prime mover 52, and an energy storage device, shown as energy storage 54. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor and the energy storage 54 is a battery system. In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby the prime mover 52 includes an internal combustion engine and an electric motor/generator and the energy storage 54 includes a fuel tank and/or a battery system.

As shown in FIG. 3, the driveline 50 includes a transmission device (e.g., a continuous variable transmission (“CVT”)), shown as transmission 56, coupled to the prime mover 52. The utilization of the CVT enables the speed of a front axle (e.g., front axle 76) of the work vehicle 10 to be modified relative to a rear axle (e.g., rear axle 86). In a turn each wheel follows a different path and, thus, spins at a different speed. The front axle average speed is higher than the rear axle average speed. The driveline 50 also includes a power divider, shown as transfer case 58, coupled to the transmission 56. The driveline 50 further includes a first tractive assembly, shown as front tractive assembly 70, coupled to a first output of the transfer case 58, shown as front output 60. The driveline 50 further includes a second tractive assembly, shown as rear tractive assembly 80, coupled to a second output of the transfer case 58, shown as rear output 62. The transmission 56 has a variety of configurations (e.g., gear ratios, etc.) and provides different output speeds relative to a mechanical input received thereby from the prime mover 52. In some embodiments (e.g., in electric driveline configurations, in hybrid driveline configurations, etc.), the driveline 50 does not include the transmission 56. In such embodiments, the prime mover 52 may be directly coupled to the transfer case 58. The transfer case 58 is configured to facilitate driving both the front tractive assembly 70 and the rear tractive assembly 80 with the prime mover 52 to facilitate front and rear drive (e.g., an all-wheel-drive vehicle, a four-wheel-drive vehicle, etc.). In some embodiments, the transfer case 58 facilitates selectively engaging rear drive only, front drive only, and both front and rear drive simultaneously. In some embodiments, the transmission 56 and/or the transfer case 58 facilitate selectively disengaging the front tractive assembly 70 and the rear tractive assembly 80 from the prime mover 52 (e.g., to permit free movement of the front tractive assembly 70 and the rear tractive assembly 80 in a neutral mode of operation). In some embodiments, the driveline 50 does not include the transfer case 58. In such embodiments, the prime mover 52 or the transmission 56 may directly drive the front tractive assembly 70 (i.e., a front-wheel-drive vehicle) or the rear tractive assembly 80 (i.e., a rear-wheel-drive vehicle).

As shown in FIGS. 1 and 3, the front tractive assembly 70 includes a first drive shaft, shown as front drive shaft 72, coupled to the front output 60 of the transfer case 58. The front tractive assembly 70 also includes a first differential, shown as front differential 74, coupled to the front drive shaft 72. The front tractive assembly 70 further includes a first axle, shown as front axle 76, coupled to the front differential 74. The front tractive assembly 70 even further includes a first pair of tractive elements, shown as front tractive elements 78, coupled to the front axle 76. In some embodiments, the front tractive assembly 70 does not include the front drive shaft 72 or the front differential 74 (e.g., a rear-wheel-drive vehicle). In some embodiments, the front drive shaft 72 is directly coupled to the transmission 56 (e.g., in a front-wheel-drive vehicle, in embodiments where the driveline 50 does not include the transfer case 58, etc.) or the prime mover 52 (e.g., in a front-wheel-drive vehicle, in embodiments where the driveline 50 does not include the transfer case 58 or the transmission 56, etc.). The front axle 76 may include one or more components.

As shown in FIGS. 1 and 3, the rear tractive assembly 80 includes a second drive shaft, shown as rear drive shaft 82, coupled to the rear output 62 of the transfer case 58. The rear tractive assembly 80 also includes a second differential, shown as rear differential 84, coupled to the rear drive shaft 82. The rear tractive assembly 80 further includes a second axle, shown as rear axle 86, coupled to the rear differential 84. The rear tractive assembly 80 even further includes a second pair of tractive elements, shown as rear tractive elements 88, coupled to the rear axle 86. In some embodiments, the rear tractive assembly 80 does not include the rear drive shaft 82 or the rear differential 84 (e.g., a front-wheel-drive vehicle). In some embodiments, the rear drive shaft 82 is directly coupled to the transmission 56 (e.g., in a rear-wheel-drive vehicle, in embodiments where the driveline 50 does not include the transfer case 58, etc.) or the prime mover 52 (e.g., in a rear-wheel-drive vehicle, in embodiments where the driveline 50 does not include the transfer case 58 or the transmission 56, etc.). The rear axle 86 may include one or more components. The front tractive elements 78 and the rear tractive elements 88 are structured as wheels. In other embodiments, the front tractive elements 78 and the rear tractive elements 88 are otherwise structured (e.g., tracks, etc.). In some embodiments, the front tractive elements 78 and the rear tractive elements 88 are both steerable. In other embodiments, only one of the front tractive elements 78 or the rear tractive elements 88 is steerable.

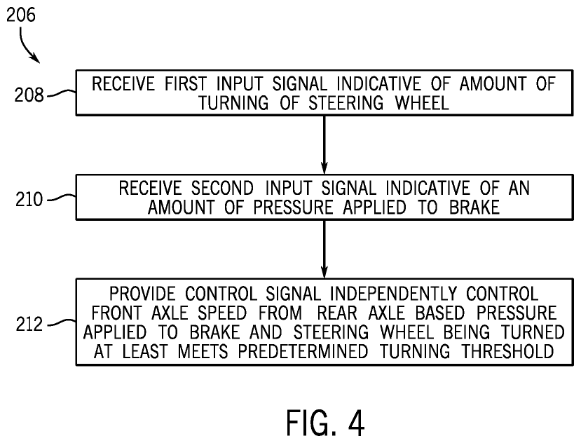

As shown in FIG. 3, the driveline 50 includes a power-take-off (“PTO”), shown as PTO 90. While the PTO 90 is shown as being an output of the transmission 56, in other embodiments the PTO 90 may be an output of the prime mover 52, the transmission 56, and/or the transfer case 58. The PTO 90 is configured to facilitate driving an attached implement and/or a trailed implement (see, e.g., trailed implement 300 in FIG. 4) of the work vehicle 10. In some embodiments, the driveline 50 includes a PTO clutch positioned to selectively decouple the driveline 50 from the attached implement and/or the trailed implement of the work vehicle 10 (e.g., so that the attached implement and/or the trailed implement is only operated when desired, etc.).

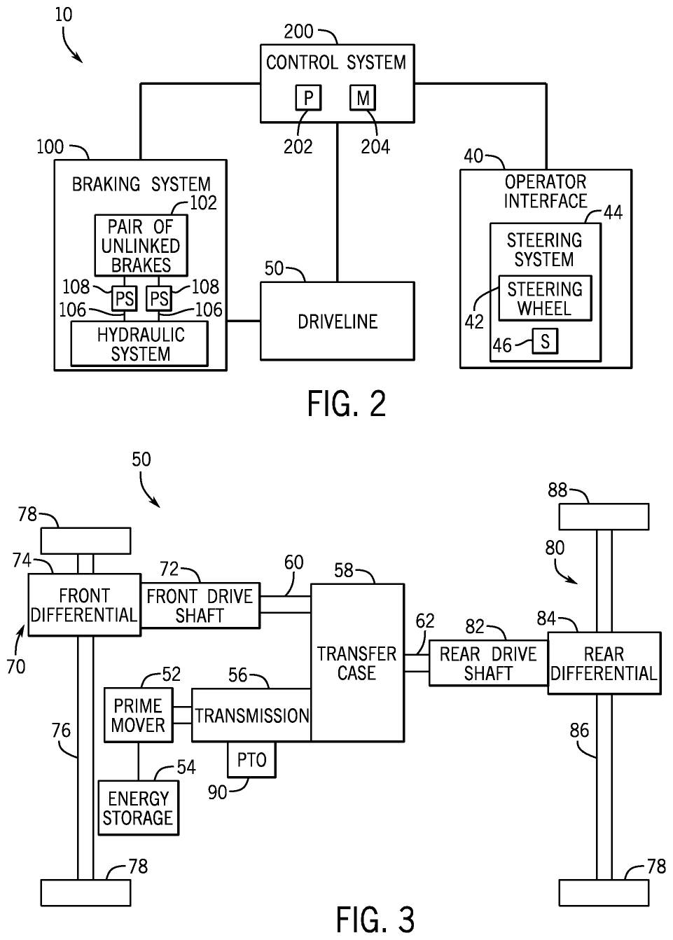

As depicted in FIG. 2, the braking system 100 includes a pair of unlinked brakes 102 (i.e., the brakes 102 are separately actuated) coupled to a hydraulic system 104 via respective hydraulic lines 106. The brakes 102 may include a left brake for braking the left rear wheel and a right brake for braking the right rear wheel. The braking system 100 also includes a respective pressure sensor 108 disposed along respective hydraulic lines of the pair of unlinked brakes 102. Each pressure sensor 108 is configured to measure an amount of pressure applied to a corresponding brake of the pair of unlinked brakes 102. Each pressure sensor 108 is communicatively coupled to the control system 200 and provides feedback (e.g., signals) related to the amount of pressure applied to a corresponding brake of the pair of unlinked brakes 102.

The control system 200 includes a processor 202 and a memory 204. In certain embodiments, the processor 202 may include one or more general purpose processors, one or more application specific integrated circuits, one or more field programmable gate arrays, or the like. Additionally, the memory 204 may be any tangible, non-transitory, computer readable medium that is capable of storing instructions executable by the processor 202 and/or data that may be processed by the processor 202. In other words, the memory 204 may include volatile memory, such as random access memory, or non-volatile memory, such as hard disk drives, read only memory, optical disks, flash memory, and the like.

The control system 200 is configured to receive both a first input signal, from the sensor 46, indicative of the amount the steering wheel 42 is being turned and a second input signal, from the respective pressure sensor 108 of a respective brake 102 of the pair of unlinked brakes 102, indicative of the amount of pressure applied to the respective brake 102 corresponding to a turn direction of the steering wheel 42 (i.e., left brake when turning left or right brake when turning right). The control system 200 is configured to provide a control signal to independently control a speed of the front axle 76 from the rear axle 86 when conducting a turn under power based on the amount of pressure applied to the respective brake 102 when the amount the steering wheel 42 is being turned at least meets a predetermined turning threshold.

The control system 200 is also configured to provide the control signal to increase the speed of the front axle 76 until the speed of the front axle 76 is greater than a speed required to match a ground speed of the work vehicle 10. The control system 200 is further configured to provide the control signal to increase the speed of the front axle in correspondence with increasing the amount of pressure applied to the respective brake 102.

In certain embodiments, the relationship between brake pressure and the speed of the front axle 76 can be tuned within the control system 200. The tuning may include setting a range of brake pressure for the response (i.e., front axle speed). The tuning may involve tying the max speed to a particular brake pressure, a fixed rpm, or other parameter. The tuning may involve setting a maximum speed of the front axle or a maximum brake pressure. In certain embodiments, the control system 200 (in response to tuning) is configured to provide the control signal to increase the speed of the front axle 76 in correspondence with increasing the amount of pressure applied to the respective brake 102 until reaching a maximum speed of the front axle 76. In certain embodiments, the control system 200 (in response to tuning) is configured to provide the control signal to increase the speed of the front axle 76 in correspondence with increasing the amount of pressure applied to the respective brake 102 until reaching a maximum amount of pressure applied to the respective brake 102. In certain embodiments, the control system 102 (in response to tuning) is even further configured to provide the control signal to increase the speed of the front axle 76 to a maximum speed upon the amount of pressure applied to the respective brake 102 reaching a predetermined pressure threshold (e.g., a low enough pressure that an insignificant amount of brake force is generated). In certain embodiments, the maximum speed of the front axle 76 can be achieved only when the rear brake (i.e., brake for left rear wheel or brake for right rear wheel) is actuated in combination of brake assisted steering and front axle overspeed.

In certain embodiments, as depicted in FIG. 2, the operator interface 40 may include a separate dedicated input device 41 may be utilized to provide an input to the control system 200 to control the front axle speed. For example, the dedicated input device 41 may include a lever, up and down buttons, or other input devices.

FIG. 4 is a flow chart of a method 206 for controlling a front axle speed of a work vehicle (e.g., work vehicle 10 in FIG. 1). The steps of the method 206 may be performed by the control system 200 of the work vehicle 10 described above. In certain embodiments, one or more steps of the method 206 may be performed simultaneously or in a different order from that depicted in FIG. 4.

The method 206 includes receiving, at a processor of the work vehicle, a first input signal, from a sensor, indicative of an amount a steering wheel of the work vehicle is being turned (block 208). The method 206 also includes receiving, at the processor, a second input signal, from a respective pressure sensor of a respective brake of a pair of unlinked brakes of the work vehicle, indicative of an amount of pressure applied to the respective brake corresponding to a turn direction of the steering wheel (block 210).

The method 206 further includes providing, via the processor, a control signal to independently control a speed of a front axle of the work vehicle from a rear axle of the work vehicle when conducting a turn under power based on the amount of pressure applied to the respective brake when the amount the steering wheel is being turned at least meets a predetermined turning threshold (block 212). In certain embodiments, providing the control signal includes providing the control signal to increase the speed of the front axle until the speed of the front axle is greater than a speed required to match a ground speed of the work vehicle. In certain embodiments, providing the control signal includes providing the control signal to increase the speed of the front axle in correspondence with increasing the amount of pressure applied to the respective brake. In certain embodiments, providing the control signal includes providing the control signal to increase the speed of the front axle in correspondence with increasing the amount of pressure applied to the respective brake until reaching a maximum speed of the front axle. In certain embodiments, providing the control signal includes providing the control signal to provide the control signal to increase the speed of the front axle in correspondence with increasing the amount of pressure applied to the respective brake until reaching a maximum amount of pressure applied to the respective brake. In certain embodiments, providing the control signal includes providing the control signal to increase the speed of the front axle to a maximum speed upon the amount of pressure applied to the respective brake reaching a predetermined pressure threshold.

In certain embodiments, instead of input from brakes, the input from a separate dedicated input device may be utilized to control the front axle speed. For example, the dedicated input device may include a lever, up and down buttons, or other input devices.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”. it is intended that such elements are to be interpreted under 35 U.S.C. 112 (f). However. for any claims containing elements designated in any other manner. it is intended that such elements are not to be interpreted under 35 U.S.C. 112 (1).

1. A work vehicle, comprising:
a front axle:
a rear axle:
a steering system configured to turn the work vehicle, the steering system comprising a steering wheel and a sensor to determine an amount the steering wheel is being turned:
a braking system configured to slow down the work vehicle, the braking system comprising a pair of unlinked brakes, wherein each brake is coupled to a respective pressure sensor configured to measure an amount of pressure applied to a corresponding brake of the pair of unlinked brakes: and
a control system configured to receive both a first input signal, from the sensor, indicative of the amount the steering wheel is being turned and a second input signal, from the respective pressure sensor of a respective brake of the pair of unlinked brakes, indicative of the amount of pressure applied to the respective brake corresponding to a turn direction of the steering wheel, wherein the control system is configured to provide a control signal to independently control a speed of the front axle from the rear axle when conducting a turn under power based on the amount of pressure applied to the respective brake when the amount the steering wheel is being turned at least meets a predetermined turning threshold.

2. The work vehicle of claim 1, wherein the control system is configured to provide the control signal to increase the speed of the front axle in correspondence with increasing the amount of pressure applied to the respective brake.

3. The work vehicle of claim 2, wherein the control system is configured to provide the control signal to increase the speed of the front axle in correspondence with increasing the amount of pressure applied to the respective brake until reaching a maximum speed of the front axle.

4. The work vehicle of claim 2, wherein the control system is configured to provide the control signal to increase the speed of the front axle in correspondence with increasing the amount of pressure applied to the respective brake until reaching a maximum amount of pressure applied to the respective brake.

5. The work vehicle of claim 1, wherein the control system is configured to provide the control signal to increase the speed of the front axle until the speed of the front axle is greater than a speed required to match a ground speed of the work vehicle.

6. The work vehicle of claim 1, wherein the control system is configured to provide the control signal to increase the speed of the front axle to a maximum speed upon the amount of pressure applied to the respective brake reaching a predetermined pressure threshold.

7. The work vehicle of claim 1, wherein the work vehicle is a tractor.

8. The work vehicle of claim 1, wherein the work vehicle is four wheel drive.

9. A system for controlling a front axle speed of a work vehicle, comprising:
a sensor configured to determine an amount a steering wheel of the work vehicle is being turned:
a pair of pressure sensors, wherein each pressure sensor of the pair of pressure sensors is configured to measure an amount of pressure applied to a corresponding brake of a pair of unlinked brakes of the work vehicle; and
a control system configured to receive both a first input signal, from the sensor, indicative of the amount the steering wheel is being turned and a second input signal, from a respective pressure sensor of a respective brake of the pair of unlinked brakes, indicative of the amount of pressure applied to the respective brake corresponding to a turn direction of the steering wheel, wherein the control system is configured to provide a control signal to independently control a speed of a front axle of the work vehicle from a rear axle of the work vehicle when conducting a turn under power based on the amount of pressure applied to the respective brake when the amount the steering wheel is being turned at least meets a predetermined turning threshold.

10. The system of claim 9, wherein each pressure sensor of the pair of pressure sensors is configured to couple to a corresponding hydraulic line of the corresponding brake of a pair of unlinked brakes of the work vehicle.

11. The system of claim 9, wherein the control system is configured to provide the control signal to increase the speed of the front axle in correspondence with increasing the amount of pressure applied to the respective brake.

12. The system of claim 11, wherein the control system is configured to provide the control signal to increase the speed of the front axle in correspondence with increasing the amount of pressure applied to the respective brake until reaching a maximum speed of the front axle.

13. The system of claim 11, wherein the control system is configured to provide the control signal to increase the speed of the front axle in correspondence with increasing the amount of pressure applied to the respective brake until reaching a maximum amount of pressure applied to the respective brake.

14. The system of claim 9, wherein the control system is configured to provide the control signal to increase the speed of the front axle until the speed of the front axle is greater than a speed required to match a ground speed of the work vehicle.

15. The system of claim 9, wherein the control system is configured to provide the control signal to increase the speed of the front axle to a maximum speed upon the amount of pressure applied to the respective brake reaching a predetermined pressure threshold.

16. A method for controlling a front axle speed of a work vehicle, comprising:
receiving, at a processor of the work vehicle, a first input signal, from a sensor, indicative of an amount a steering wheel of the work vehicle is being turned:
receiving, at the processor, a second input signal, from a respective pressure sensor of a respective brake of a pair of unlinked brakes of the work vehicle, indicative of an amount of pressure applied to the respective brake corresponding to a turn direction of the steering wheel; and
providing, via the processor, a control signal to independently control a speed of a front axle of the work vehicle from a rear axle of the work vehicle when conducting a turn under power based on the amount of pressure applied to the respective brake when the amount the steering wheel is being turned at least meets a predetermined turning threshold.

17. The method of claim 16, wherein providing control signal comprises providing the control signal to increase the speed of the front axle in correspondence with increasing the amount of pressure applied to the respective brake.

18. The method of claim 17, wherein providing control signal comprises providing the control signal to increase the speed of the front axle in correspondence with increasing the amount of pressure applied to the respective brake until reaching a maximum speed of the front axle.

19. The method of claim 17, wherein providing control signal comprises providing the control signal to increase the speed of the front axle in correspondence with increasing the amount of pressure applied to the respective brake until reaching a maximum amount of pressure applied to the respective brake.

20. The method of claim 16, wherein providing control signal comprises providing the control signal to increase the speed of the front axle until the speed of the front axle is greater than a speed required to match a ground speed of the work vehicle.
